(19) United States
(12) Patent Application Publication
(10) Pub. No.: US 2023/0141264 A1
(43) Pub. Date: May 11, 2023

(54) BOLT TRANSDUCER

(71) Applicant: Tribosonics Limited, Sheffield (GB)

(72) Inventors: Jack SANDS, Sheffield (GB); Philip HARPER, Sheffield (GB)

(21) Appl. No.: 17/916,231

(22) PCT Filed: Mar. 31, 2021
(86) PCT No.: PCT/EP2021/058496

§ 371 Date: Sep. 30, 2022

(30) Foreign Application Priority Data
Mar. 31, 2020 (GB) 2004756.9

(51) Int. Cl. G01N 29/04; G01N 29/07; G01N 29/44

(52) U.S. Cl. CPC G01N 29/043; G01N 29/07; G01N 29/4427; G01N 2291/011; G01N 2291/02854; G01N 2291/044; G01N 2291/106; G01N 2291/2691

(57) ABSTRACT

In one aspect, a method of determining a parameter of a fastener includes providing an input to an ultrasonic transducer of a transducer arrangement, wherein the transducer is attached to a fastener and the input results in the transmission of an ultrasonic wave into the fastener. A transducer output is received, which is indicative of a reflected ultrasonic wave received by the transducer. The transducer output is compared to known data for the parameter to determine whether the parameter of the fastener is within a predetermined range.

### FIELD OF INVENTION

The invention relates to a bolt transducer and methods of sensing properties of a bolt using ultrasound.

### BACKGROUND

There are many applications in which bolts or other fasteners are employed to construct structures of various sorts. Often such bolts and fasteners are required to be tightened to a predetermined torque or tension. Some applications require periodic or constant monitoring to determine whether they fall outside of permitted operating envelopes.

The present invention seeks to provide a transducer which is operable to determine one or more physical properties or operating condition of a fastener.

### SUMMARY

The present invention provides a method of determining a parameter of a fastener according to the appended claims.

Disclosed herein is a method of determining a parameter of a fastener, comprising: providing an input to an ultrasonic transducer of a transducer arrangement, wherein the transducer is attached to a fastener and the input results in the transmission of an ultrasonic wave into the fastener; receiving a reflected ultrasonic wave by the transducer and providing a transducer output; and comparing the output to known outputs for the parameter to determine whether the parameter of the fastener is within a predetermined range.

The method may further comprise: providing an output signal indicative of a condition of the fastener, wherein the condition of the fastener relates to the determination of whether the fastener is within the predetermined range. The parameter may be a time of flight of the ultrasonic wave, or may be derived from the time of flight.

The transmission may be a first ultrasonic transmission. The method may further comprise providing a second ultrasonic transmission, wherein the parameter is a ratio of a time of flight of the first and second ultrasonic transmissions. The first ultrasonic transmission may comprise a pressure wave. The second ultrasonic transmission may comprise a shear wave.

The known output may comprise a plurality of measurements taken from one or more fasteners having different tensioned lengths. The tensioned lengths may be defined as a portion of the bolt which is under tension, or a tensioned portion length. The tensioned portion length may correspond to the thickness of the components being bolted together by the fastener. Hence, the tensioned portion length may be a length defined by the opposed clamping surfaces of the bolt head and tensioning element e.g. a nut, which bear against the component being clamped when in tension. The plurality of measurements may comprise a first set of measurements corresponding to a first bolted length and a second set of measurements corresponding to a second bolted length. Each of the first and second set of measurements may include a plurality of measurements corresponding to different levels of tension in the fastener.

The tensioned portion length may comprise a length of the fastener between an end face of the fastener against which the ultrasonic transmissions are reflected and a nut which forms part of the fastener. The face against which the ultrasonic transmissions are reflected may be the primary face which directly opposes the face on which the transducers are mounted.

The known data may comprise a ratio of the tensioned portion length to the total length of the fastener. The known data may comprise a ratio of the total length to the length of the exposed or unstressed threads which are distal to the nut and tension portion of the fastener.

The method may further comprise obtaining the known data. The known outputs may be determined empirically from stage loading one or more fasteners. The known outputs may comprise historic data for a fastener.

The transducer may comprise a plurality of transducer elements arranged in an array on a portion of the fastener. The method may further comprise: transmitting an input from each of the transducer elements; receiving the reflected ultrasonic waves by the transducer elements and determining a stress profile for the fastener on the basis of the received reflected ultrasonic waves.

The transmitting of the input from each of the transducer elements may comprise simultaneously transmitting the input from each of the transducer elements. The stress profile may be a radial stress profile. Determining a stress profile may comprise comparing the time of flight of any two of the received reflected ultrasonic waves.

The method may further comprise: determining the duration of a response envelope. The response envelope may comprise the received reflected ultrasonic waves from each of the transmitted inputs from each of the transducer elements.

The stress profile may comprise an axial section. The method may further comprise determining the axial section using tomography techniques.

Receiving the reflected ultrasonic waves by the transducer elements may comprise receiving the reflected ultrasonic waves resulting from each of the inputs of the transducer elements at each of the transducer elements.

The ultrasonic transducer may comprise an RF transceiver, and the method may further comprising: attaching a reader to the transceiver; providing the input from the reader; receiving the output via the reader. The transceiver may be a wireless transceiver. The power may be provided to the ultrasonic transducer via the reader. The reader may be temporarily attached to the transceiver for the duration providing the input and receiving the output.

A method of verifying the correct installation of a fastener may comprise any of the aforementioned methods.

A further method of determining a parameter of a fastener comprises: providing an input to an ultrasonic transducer of a transducer arrangement, wherein the transducer is attached to a fastener and the input results in the transmission of an ultrasonic wave into the fastener; receiving a transducer output from the ultrasonic transducer, the transducer output being indicative of a reflected ultrasonic wave received by the ultrasonic transducer; and comparing the transducer output to known data for the parameter to determine whether the parameter of the fastener is within a predetermined range. This method may comprise any of the features of the aforementioned methods.

An apparatus may be provided, wherein the apparatus comprises a processor configured to perform any of the methods disclosed herein. For example, the apparatus may comprise one or more processors operatively coupled to a memory, wherein the memory comprises instructions. When executed by the one or more processors, the instructions may cause the apparatus to perform any of the methods disclosed herein. The apparatus may further comprise a transducer arrangement as described herein.

A further method of determining a parameter of a fastener may comprise: providing an input to a plurality of ultrasonic transducer elements of a transducer arrangement, wherein the transducer elements are attached to a fastener and the input results in the transmission of a plurality of ultrasonic waves into the fastener from the transducer elements; receiving the reflected ultrasonic waves by the transducer elements and determining a stress profile for the fastener on the basis of the received reflected ultrasonic waves.

A yet further method of determining a plurality of calibration plots for use in determining a parameter of a fastener may comprise: measuring, for a plurality of fasteners, the parameter under different conditions wherein the different conditions comprise a plurality of tensioned length to total length for each of the plurality of fasteners.

Described herein is a transducer arrangement for measuring a parameter of a fastener. The parameter may comprise: a housing comprising a receiving end for receiving a portion of the fastener so as to be mountable to the fastener; a transducer located within the housing and presented for contact with a portion of the fastener; wherein the transducer is configured to be rotatable relative to the housing.

The housing may be separated from the transducer by a bearing wherein the bearing allows the relative rotation between the transducer and housing. The bearing may be a thrust bearing.

The transducer arrangement may further comprise an intermediate housing in which the transducer is located. The bearing may be located between the housing and intermediate housing.

The transducer may be displaceable along an axis relative to the receiving end such that the transducer is movable towards and away from the receiving end and fastener.

The transducer may be urged towards the receiving end along the axis.

The transducer arrangement may further comprise a biasing member. The biasing member may be configured to urge the transducer towards the receiving end. The receiving end may comprise a threaded portion for threaded engagement with the fastener.

The fastener may be a bolt. The bolt may comprise a head, a shaft and a nut. The one or more transducer may be received on an end surface of the bolt. The end surface may be a distal surface. The distal surface may be at the terminal end of the threaded end of the bolt.

The transducer arrangement may further comprise a transceiver for receiving and transmitting one or more signals to or from the transducer.

The transceiver may be a wireless transceiver. The transceiver may be located at an opposite end of the housing relative to the receiving end.

The transducer arrangement may further comprise a plurality of transducers.

The transducer may be configured to transmit a pressure wave into the fastener. The transducer may be configured to transmit a shear wave into the fastener.

The plurality of transducers may include at least one transducer configured to transmit pressure waves and at least one transducer configured to transmit shear waves. The transducer arrangement may further comprise a transducer configured to transmit both a pressure wave and a shear wave.

The plurality of transducers may be arranged in a radial distribution from a central axis towards a peripheral edge of the receiving end of the fastener. The transducers may be connected in parallel.

The transducer arrangement may further comprise a signal processor configured to receive and process the signals generated by the reflected waves.

The signal processor may be configured to process the signals in parallel.

The transducers may each be connected to a separate channel of the signal processor. The transducer arrangement may further comprise a reader which is electrically connectable to the transducer so as to receive a signal therefrom.

The reader may be a wireless reader which interfaces with the wireless transceiver.

In another aspect the present disclosure provides a transducer arrangement for measuring a parameter of a fastener. The transducer arrangement may comprise: a housing comprising a receiving end for receiving a portion of the fastener so as to be mountable to the fastener; a transducer located within the housing and presented for contact with a portion of the fastener; wherein the transducer is displaceable along an axis relative to the receiving end such that the transducer can be moved towards and away from the receiving end and fastener.

The transducer may be urged towards the receiving end along the axis. The transducer may further comprise a biasing member which urges the transducer towards the receiving end.

The axis may be an insertion axis along which the housing is configured to receive the fastener.

The transducer may be configured to be rotatable relative to the housing about a rotational axis. The insertion axis and rotational axis may be co-axial.

The biasing member may comprise a compression spring.

The biasing member may be centred on the insertion axis and/or rotational axis.

The biasing member may urge against a rearward side of the transducer or a transducer carrier.

The transducer arrangement may further comprise a plurality of transducers.

In yet a further aspect, the present disclosure provides a transducer arrangement for measuring a parameter of a fastener. The transducer arrangement may comprise: a housing comprising a receiving end for receiving a portion of the fastener so as to be mountable to the fastener; a plurality of transducers located within the housing and presented for contact with a portion of the fastener.

At least one of the transducers may be configured to transmit a pressure wave into the fastener.

All of the transducers may be configured to transmit a pressure wave into the fastener.

At least one transducer may be configured to transmit a shear wave into the fastener.

The plurality of transducers may include at least one transducer configured to transmit pressure waves and at least one transducer configured to transmit shear waves.

The plurality of transducers may be arranged in a radial distribution from a central axis towards a peripheral edge of the receiving end of the fastener.

The transducer arrangement may comprise a radial distribution which traverses the central axis of the fastener.

The transducers may be arranged in a linear array.

The transducer arrangement may further comprise a signal generator configured to provide an input to each of the plurality of transducers elements.

The signal generator may be configured to provide an input to each of the plurality of transducers elements sequentially.

The signal generator may be configured to provide an input to each of the plurality of transducers simultaneously.

The transducer arrangement may further comprise a signal processor configured to receive the output signals from the plurality of transducers.

The signal processor may be configured to receive and process signals from each of the transducers in turn.

The signal processor may be configured to receive and process signals from each of the transducers simultaneously.

The transducer arrangement may further comprise an output device configured to provide an output to a user. The output may provide an indication of whether the fastener parameter is within a predetermined range.

The output device may be configured to provide one or more of: a picture; plot; a chart and an alert.

The plurality of transducers may be configured to be rotatable relative to the housing.

The plurality of transducers may be configured to be longitudinally displaceable relative to the housing.

The signal processor may be configured to process the signals in parallel.

The transducers may each be connected to a signal processor.

A transducer arrangement may further comprise a transceiver for receiving and transmitting one or more signals to or from the transducer.

The transceiver may be a wireless transceiver.

The skilled person will appreciate that except where mutually exclusive, a feature described in relation to any one of the aspects, examples or embodiments described herein may be applied to any other aspect, example, embodiment or feature. Further, the description of any aspect, example or feature may form part of or the entirety of an embodiment of the invention as defined by the claims. Any of the examples described herein may be an example which embodies the invention defined by the claims and thus an embodiment of the invention.

### BRIEF OVERVIEW OF FIGURES

The invention will now be described, by way of example only, with reference to the accompanying drawings, in which:

FIG. 1 shows a transducer arrangement for measuring a property of a fastener;

FIG. 2 shows an alternative transducer arrangement;

FIG. 3 shows a fastener having a transducer mounted thereto;

FIG. 4a shows a calibration plot for a fastener;

FIG. 4b shows the calibration plot of FIG. 4a with upper and lower limits of acceptable load;

FIG. 5 shows a fastener comprising a plurality of transducer elements;

FIGS. 6a and 6b show calibration plots;

FIG. 7 shows a further transducer arrangement;

FIG. 8 shows a calibration plot for use with the transducer arrangement of FIG. 7;

FIG. 9 shows a flow diagram of a method of operating a transducer arrangement;

FIG. 10 shows a flow diagram of a further method of operating a transducer arrangement;

FIG. 11 shows yet a further arrangement of a transducer arrangement;

FIGS. 12a and 12b show an alternative attachment mechanism of a transducer arrangement; and

FIG. 13 shows a yet further alternative attachment mechanism of a transducer arrangement.

### DETAILED DESCRIPTION

Throughout this specification, references to axial should be taken to be in relation to either or both of an insertion axis which relates to the axis along which a fastener is received by a transducer arrangement, and a rotational axis about which the transducer rotates. The insertion axis and rotational axis may be coaxial and both are defined in more detail below in relation to specific examples. Rear and rearwards should be taken with respect to the receiving end which receives the fastener. Thus an element moving rearwards is moving away from the receiving end, into a housing of the transducer. The front of the transducer arrangement refers to the part which faces and/or receives the fastener.

The term transducer may be taken to be any device which converts one energy form into another energy form. The terms transducer arrangement and sensor arrangement may be used interchangeably.

Principally, the present disclosure is concerned with ultrasonic transducers which are configured to transmit and receive ultrasonic signals into a fastener. The transducer of the present disclosure may comprise a plurality of transducers, the individual transducers of which may be referred to herein as transducer elements.

FIG. 1 shows a transducer arrangement 100 for measuring a property of a fastener 16. The transducer arrangement 100 may comprise a housing 10 having a receiving end 12 for receiving a portion of the fastener 16. The receiving end 12 may be configured so as to allow the transducer arrangement to be directly mounted to the fastener 16. The transducer arrangement 100 may also include a transducer 14 located within the housing 10 and presented for contact with a portion of the fastener 16.

The transducer arrangement 100 shown in FIG. 1 may be used to measure a property of a fastener 16. As noted above, the housing 10 may have a receiving end 12 for receiving a portion of the fastener 16 so as to be mountable to the fastener 16 and a transducer 14 located within the housing and presented for contact with a portion of the fastener 16.

As shown in FIG. 1, in one example, the housing 10 may include a threaded fitting for attaching to the fastener 16. Alternatively, a bayonet or other fitting may be used to attach the transducer arrangement 100 to the fastener 16 by rotation. There may be other examples in which the housing is clamped or otherwise attached to the fastener 16 without the need for relative rotation.

With the housing 10 and transducer 14 arrangement provided as part of the present disclosure, the transducer 14 may be mounted to the fastener 16 in a fixed relation, whilst the housing 10 is rotated. In such a situation, the housing 10 may be rotatable about an axis of rotation 18 in relation to the fastener 16 and/or transducer 14. Thus, the transducer 14 may be configured to be rotatable relative to the housing 10. The relative rotation is such that it may allow the housing 10 to be rotated relative to the transducer 14 and fastener 16 when attaching the transducer arrangement 100 and transducer 14 to the fastener 16.

In some examples, the transducer 14 may be configured to move linearly relative to the housing 10. The linear movement of the transducer 14 relative to the housing 10 is such that the transducer 14 can be urged against a mounting portion of the fastener 16 independently of the housing 10. In this way, it may be possible to provide the transducer 14, or an element thereof, with a contacting force which is predetermined and substantially independent from the contact pressure between the housing 10 and fastener 16. Hence, the contact pressure of transducer 14 may be reliably and repeatably achieved when the transducer arrangement 100 is mounted to the fastener 16.

As shown in FIG. 1, to enable the linear movement, the transducer 14 may be located within a cavity or passageway 20 which extends away from the receiving end 12 and in-line with an insertion axis 22 such that the transducer may move rearwards as the housing advances on to the fastener 16.

Other parts of the transducer arrangement 100, which may be optional, include a transceiver 24 in the form of a wireless transceiver, an intermediate housing located within the external housing, a transducer sleeve, a backing material and/or a biasing member which urges the transducer towards the target in use.

Generally, throughout this disclosure the fastener 16 is referred to as being a bolt. Hence, the fastener 16 may be an elongate member having a longitudinal axis with a head (not shown), configured to engage with a tool, and threaded portion at opposing ends thereof. The transducer arrangement 100 may be mounted to any part of the fastener 16 such that pressure waves or transverse waves can be transmitted into the fastener and received as required by the measurement method being implemented. In the example of a bolt being interrogated by ultrasonic waves, the ultrasonic transducer may be mounted to the head or threaded end. In some embodiments, the fastener may comprise a threaded rod having nuts on either end or be a threaded stud.

The housing 10 may comprise a peripheral external wall which defines a body of the housing. An internal cavity 26 may be provided in which the fastener 16 and transducer 14, or parts thereof, may be located. As noted above, the housing 10 may include a receiving end 12 into which a portion of the fastener 16 may be received and attached, in use. The receiving end 12 may comprise an opening in an external wall of the housing 10 which provides a gateway to the internal cavity 26. The internal cavity 26 may be configured to receive the fastener 16 along the insertion axis 22. The exterior and/or interior of the housing 10 may be generally axi-symmetrical.

The transducer 14 may be located within the housing 10 and presented in such a way that it can contact the fastener 16 in use. The transducer 14 may have a mounting surface 28 which abuts a corresponding portion of the fastener 16. The mounting surface 28 may be exposed to the receiving end 12 and be visible through the opening in the housing 10, prior to be mounted on a fastener 16. The mounting surface 28 may be provided by a planar surface of the transducer 14.

The transducer 14 may comprise a plurality of transducer elements and may be any suitable transducer (or transducer elements) known in the art. The transducer 14 of particular interest to this disclosure is an ultrasonic transducer which is configured to a send and/or receive ultrasonic signals into or out of the fastener 16 to determine one or more properties of the fastener 16. The ultrasonic transducer will typically be a piezoelectric element, but this is not a limitation.

The receiving end 12 (or other part of the housing 10) may include one or more features which engage with the fastener 16 or a surrounding body such that the transducer 14 can be mounted to the fastener 16 in a predetermined relation. In the example shown in FIG. 1, there is provided a housing 10 having a threaded portion on an internal surface of the housing internal cavity 26, within a mouth of an internal cavity 26. The threaded portion 26 may be sized for engagement with a corresponding threaded portion of a fastener, such as a bolt or stud, which is to be interrogated.

The surrounding body referred to in the preceding paragraph may be any body which is adjacent to or proximate to the fastener to be tested and may form part of the structure which is held in position by the fastener.

To enable attachment of the housing 10 and/or transducer arrangement more generally to the fastener 16, the housing may be configured to be rotatable around a rotational axis 18. In the case of the threaded engagement shown in FIG. 1, the axis of rotation 18 may be concentric with the housing 10, as is well known in the art. In such a case, it will be apparent that the axis of rotation 18 and axis of insertion 22 are coaxially arranged, as shown in FIG. 1.

In use, the transducer arrangement 100 may be presented to a fastener 16 which is inserted into the receiving end 12. The housing 10 may be rotated upon engagement with the threaded portion 30 until the transducer 14 contacts the fastener 16. It will be appreciated that a predetermined amount of torque may be required to provide the contact pressure between the transducer 14 and the fastener 16. As such the housing 10 may be torqued to by a prerequisite amount using a suitable tool, as is well known in the art, or by hand. It will be appreciated that in some situations, for particular types of transducers, some form of medium may be required between the mounting surface 28 and fastener 16 to enhance the acoustic coupling therebetween.

Once in situ, the transducer 14 may be employed to excite the fastener 16 with ultrasonic waves and the resultant reflections sensed. As can be seen from FIG. 1, the sensed signals may be transmitted to a suitable signal processor 32 which can collect and process the data in a known manner to provide one or more parameters about the fastener 16. As can be seen in FIG. 1, the connection between the transducer arrangement 100 and the signal processor 32 may be hardwired via a suitable cable 34, but may be wireless in some embodiments.

As will be appreciated, it is necessary to connect the transducer 14 to an input/output connection to allow data signals generated by the transducer 14 to be captured. The input/output connection may be provided by any suitable connection, and may be wired or wireless. The input/output connection may, for example, comprise a cable or wire which connects directly or indirectly to the transducer 14 or wires which extend therefrom. The transducer arrangement 100 may include a connector which is located electrically between the transducer 14 and an i/o connector allowing the transducer to be interchangeable.

In some examples, the input/output connection may include a transceiver 24 to receive and/or transmit one or more signals to or from the transducer 214. The transceiver may include an antenna which is configured for wireless transmission. The wireless transmission may be a short range system in which a reader is placed in close proximity to the transceiver.

The reader may be provided on a pole or other elongate member to allow an operator to place the reader on the transducer arrangement at a distance.

The transducer arrangement 100 may be powered by the transceiver 24. Hence, when a reader 25 is placed in a predetermined location proximate to the transceiver 24, one or more antennas may receive electromagnetic waves which provide data and power for driving the transducer arrangement 100. The wireless transceiver 24 may include one or more coils. The transceiver 24 may include circuitry for processing the input or output for transmission or may be passive thereby providing In some embodiments the transceiver 24 and reader may be provided by, for example, a pair of corresponding RF coils which are respectively embedded in the housing and reader respectively.

The transceiver 24 may be located towards the rear of the transducer so as to be distal to the fastener. The distal placement of the transceiver 24 may provide a preferable location for access by an operator to connect to the transducer arrangement 100 and locate a reader 25. In the case where a manual reader 25 is used to engage with the i/o connection, the transceiver 24 may include a rearward facing surface which is shaped to receive a corresponding reader 25.

In use, an engineer may attach the reader 25 to the transceiver 24. The reader 25 may be pre-programmed to provide a data signal which drives the transducer 14. Data may be received and processed. The reader system may include one or more output devices which indicate whether a fastener is within a predetermined range of a measure parameter.

As will be appreciated from the above, the transducer 14 may be electrically connected to a signal processor 32 such that an output signal generated by the transducer 14 can be communicated thereto.

In addition to comprising a signal processor 32, the system may also include a signal generator 36 which provides the driving signal for the transducer 14. The signal generator may be collocated with the signal processor 32 and may share the electrical connection with the transducer arrangement 100. Thus, a pulse may be provided from the signal generator to the transducer which generates an ultrasonic pulse which is transmitted into the fastener 16 prior to the reflected signal being received and sent to the signal processor 32 for processing.

The transducer arrangement 100 may find application in any suitable location in which one or more fasteners may require monitoring or assessing to determine one or more properties or state of the fastener and/or body to which they are attached. In some examples, the transducer arrangement 100 may be used on a wind turbine arrangement. In particular, the transducer arrangement 100 may be used to measure properties of fasteners that attach a wind turbine tower to a foundation block.

The use of the transducer arrangement 100 may be permanent or temporary. Thus, the transducer arrangement 100 may be used intermittently for maintenance purposes, or during installation to determine the fastener 100 is correctly torqued or tensioned and does not comprise a weakness or flaw which causes one or more deleterious stress concentrations, for example. In one example, a given fastener 16 may be required to be tightened to a minimum or maximum torque or tension which may be determined with the transducer arrangements and methods of sensing as described herein.

The property measured by the transducer arrangement 100 may be any of interest. In the case of an ultrasonic transducer, as intimated above, the transducer may be used to determine the stress within the bolt. However, this should not be seen as a limitation and the transducer may be used for other purposes in different settings. The stress measurement may be used to determine the tightness (torque/tension) of the fastener, or any other useful property such as loading, fatigue or some other failure mechanism which may be predicative of a failure or the requirement of a scheduled maintenance.

The transducer arrangement 100 may be permanent or temporary. In the example of a permanent arrangement, the transducer arrangement 100 may be attached to or be an integral part of the fastener 16 such that it can be installed with the fastener 16 or shortly thereafter. For example, the transducer arrangement 100 may be installed during the commissioning of the structure in which the fastener is employed and left in situ for a predetermined amount of time or the service lifetime of the fastener 16. In such a scenario, data may be permanently retrieved from the transducer 100 via a suitable wired or wireless transceiver which provides the data acquired by the senor to a receiving entity for processing and analysis. By ‘permanent’ it will be understood that the capturing and transmission of transducer data may be intermittent or periodically carried out and in accordance with a desired schedule, and not necessarily constant.

In a temporary arrangement, the transducer arrangement 100 may be attached to a fastener 16 for a limited duration which is sufficient for the condition of the fastener to be determined. Thus, for example, the transducer arrangement 100 may be attached to a first fastener 16 in a plurality of fasteners to obtain data relating to the first fastener, prior it being moved to a second fastener to obtain second data relating second fastener. Thus, the transducer arrangement 100 may form part of a piece of test equipment which may be carried by a maintenance engineer or the like so that fasteners 16 can be assessed as part of a maintenance or installation/validation schedule.

In some examples, the transducer 100 may be permanently attached to a fastener but be intermittently connected to a portable transceiver which either collects data held within the transducer arrangement 100 and/or provides an input with which to excite the transducer 16.

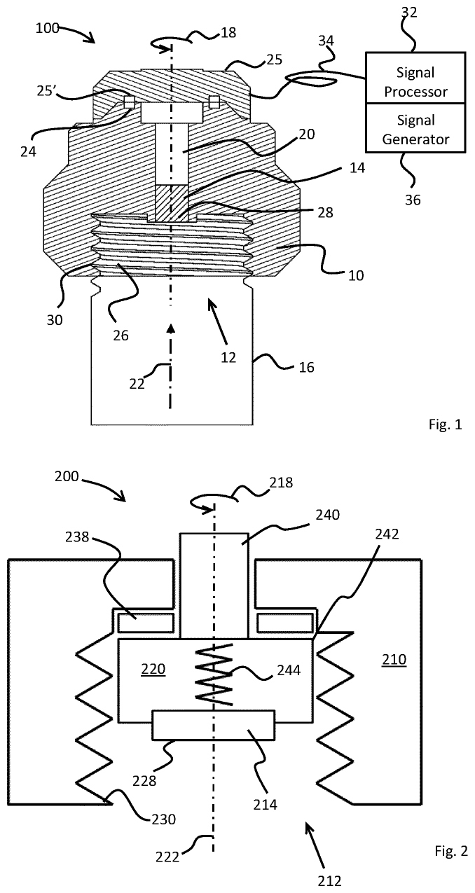

Moving to FIG. 2, there is shown a further example of a transducer arrangement 200. The transducer arrangement 200 of FIG. 2 is similar to that shown in FIG. 1 in that it includes a housing 210 which receives a fastener (not shown) in use such that a transducer 214 may be mounted on to the fastener via a mounting surface 228. As with FIG. 1, the housing 10 may include a receiving end 212 which is adapted to receive the fastener along an insertion axis 222. The housing 10 may include a threaded portion 230 which rotatably receives a corresponding portion of the fastener.

The transducer arrangement 200 may include an intermediate housing 242 which resides between the housing and the transducer. The intermediate housing may carrier the transducer 214 and be referred to as a transducer carrier. The transducer carrier 242 may comprises a body portion and a spindle or shaft which extends from a rear surface of the body portion. The transducer 214 may be mounted to a forward facing surface of the body portion so as to be exposed to the opening in the receiving end 212 and presented for mounting to on a portion of the fastener. The body portion may be hollow and comprises one or more ancillary components such as a biasing member 244 which is described in more detail below. Additionally or alternatively, the body portion may comprise one or more cavities or passageways for receiving electrical connections (not shown) which provide electrical communication between the transducer 214 and an output connection of the transducer arrangement 200.

Other parts which are common to both the transducer arrangements 100, 200 of FIG. 1 and FIG. 2 will not be described further here, for the sake of brevity, but the skilled person will appreciate that many of the features described in connection with FIG. 1 may be applicable to the example provided in FIG. 2.

The transducer arrangement 200 may be configured to provide the relative rotation between the housing 210 and the transducer 214. In order to provide the relative rotation, the transducer 214 may be provided within the housing 210 on a bearing arrangement. The bearing arrangement may comprise one or more bearings 238 sandwiched between corresponding surfaces of the transducer 214 and housing 210 (or one or more intermediate members) so as to provide the relative rotation. The one or more bearings may comprise an axial bearing, such as a thrust bearing. The bearing may be provided on opposing axial faces of a transducer carrier 242 and housing 210. The bearing 238 may encircle the rotational axis 218 and may be located about a shaft portion 240 to the rear (that is, distal in relation to the receiving end) of the transducer carrier 242 so as to radially locate the bearing 238 with respect to the transducer 214.

The bearing 238 may be provided by a disc of suitable material, which may have a suitably low coefficient of friction, or may include one or more bearings, such as roller bearings or ball bearings, which promote the relative rotation of the housing 214 and transducer carrier 242. It will be appreciated that other bearing arrangements may be possible.

It will be appreciated that, as noted above, it may be advantageous to provide a known amount of contact pressure between the transducer and the fastener. This may promote the contact between the transducer and may allow for better and more repeatable coupling between the two parts.

Hence, in some examples, the transducer 214 may be mounted to the transducer arrangement 200, e.g. the housing 210, so as to be longitudinally displaceable. In being longitudinally displaceable, the contact pressure between the transducer 214 and the housing 210 may be limited to a predetermined value, range or threshold. That is, the transducer 214 may be configured to retract rearwards into the housing 210 as the fastener is inserted into the 210 housing.

In the example of FIG. 2, the transducer arrangement 200 includes a biasing member 244 which biases the transducer towards the front of the housing 210 and the fastener. The biasing member 244 may be any suitable component which is capable of providing forward driving force which urges the transducer 214 forwards, and also provides a resilient bias which allows the transducer 214 to retract under a predetermined axial load.

The biasing member 244 may be a compression spring which extends between the housing 210 and the transducer 214, or associated intermediary components such as the transducer carrier 242. In the example of FIG. 2, the compression spring is coaxially arranged with the insertion axis, 222 such that it provides the resilient bias along the insertion axis 222.

The transducer 214 may comprise a rearward facing surface which axially opposes a forward facing surface of the housing 214 or transducer carrier 242 In other examples the biasing member 244 may be provided between the transducer carrier 242 and an internal facing surface of the housing 210, either directly or indirectly. The compression spring may be located within the thrust bearing 238.

It will be appreciated that the longitudinal movement and the rotational movement between the transducer 214 and the housing 210 may be provided in the same or different embodiments, such that a transducer which is configured to rotate relative to the housing 210 may or may not slide longitudinally within the housing 210, and vice versa.

In use, as the fastener is received within the housing 210, the transducer 214 abuts a surface of the fastener, such as the end face of the threaded portion, before being urged rearwards against the force of the biasing member 244. The biasing member 244 is configured to provide a predetermined amount of compressive force to the rear side of the transducer 214 such that the contact pressure between the transducer and fastener mounting surface is controlled. This helps ensure that the contact pressure is repeatable and within a predefined tolerance which aids the performance of the transducer 214.

In addition to the above described features, the transducer arrangement 200 may also comprise a connector (not shown) for electrically connecting the transducer 214 and the transceiver. The connector is conventional and allows the transducer 214 to be changed, thereby allowing a degree of configurability to the transducer arrangement. The connector may be housed within the cavity 220 or transducer carrier shaft 240.

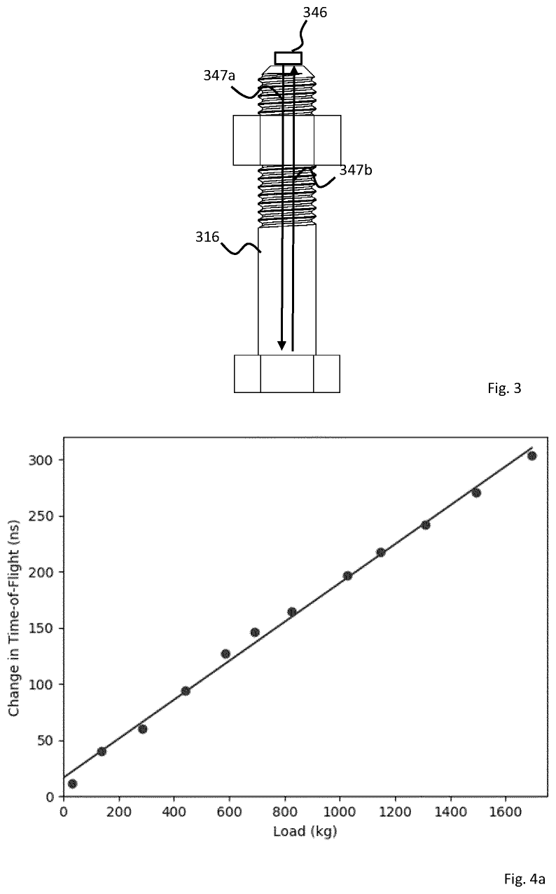

As noted above, the transducer 214 may be arranged on an end surface or other portion of the fastener and may be any type known in the art. FIG. 3 shows an ultrasonic transducer 346 placed on the end face of a fastener 316 in the form of a bolt. The ultrasonic transducer 346 may be incorporated with the transducer arrangements 100, 200 described in conjunction with either of FIG. 1 or 2, or any other alternative arrangement. The transducer 346 may be concentrically mounted on the end face. The transducer 346 may be coupled using a suitable contact medium such as an ultrasonic gel, epoxy or the like.

The transducer 346 may be a longitudinal transducer which transmits 347a a pressure wave into the fastener 316 along the length thereof. Thus, in use the transducer 346 may be excited with a suitable input waveform, such as a pulse, and the response 347b, i.e. the reflected wave, detected by the transducer 346 produces a corresponding output signal. The generated output signal may be communicated to a signal processing unit via a suitable transmission network, some options for which are discussed above.

One characteristic/parameter of interest in fasteners is the stress which occurs as a process of the installation and/or in service. The stress may be tensile as is well known in the art. Providing a longitudinal transducer 346 which transmits a pressure wave along the length of a fastener 316 can reveal information about the stress under which the fastener is put. For example, if the bolt of FIG. 3 is under a tensile stress which leads to an amount of elongation, the time of flight may increase. Knowing the time of flight and assessing this against an expected value can be indicative of the stress in the bolt and whether it is within a predetermined range.

In order to determine the amount of elongation and stress the method of interrogating the fastener may include obtaining a time of flight vs load plot, which may be referred to as a calibration plot for the purpose of the present disclosure. The calibration plot may be dependent on the type of material and dimensions of the fasteners being interrogated and will be specific to particular fasteners. To account for this, the calibration plot may be determined from empirical data in which a given fastener comprising a given material is stage loaded and the time of flight determined for each value of load.

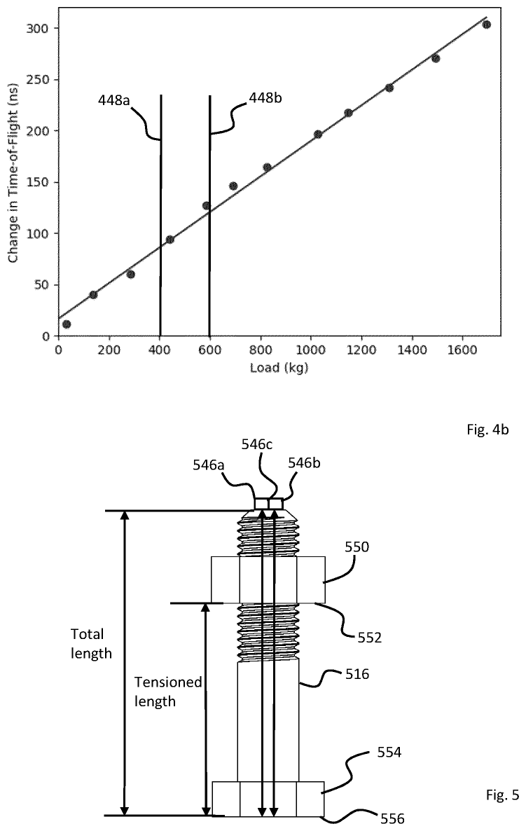

FIG. 4a shows a calibration plot of a given bolt. To provide the calibration plot, the bolt may be stage loaded at a plurality of points, as indicated by the dots, which are distributed between an unloaded state and a maximum permissible load (or some other predetermined maximum). By stage loaded it is meant that different loads can be applied to the bolt and a parameter of interest taken at each load stage. For example, for each load, the transducer may be used to determine the time of flight or change in time of flight. Once all the points have been determined, a best fit line can be used to provide a line against which ‘in-service’ measurements can be assessed. Thus, in use, a measurement of an installed fastener can be taken and the time of flight compared against the predetermined empirical data to provide a reasonable estimation of the load. The load can be associated with a level of stress using known techniques, if required.

It will be appreciated that to provide repeatability in the measurements it may be desirable to ensure that the bolt used to produce the calibration data is the same in terms of material and dimensions (in particular, length), as those which are used in service. Further, as the time of flight may be affected by a heat treatment used on the bolt, it may be desirable to ensure the calibration bolt is selected from a given batch of bolts which has undergone the same manufacturing process to ensure that the effects of the manufacturing process, including any heat treatments is the same. Nevertheless, this can be determined on a case by case basis and on a consideration of the accuracy required. As described below in relation to FIG. 5, it may also be desirable to determine the portion of the bolt which is tensioned and/or the portion which is untensioned (i.e. the free end of the bolt) as the extent of these may affect the measurements. Hence, the stage loading may be carried out for a plurality of different tensioned portion lengths for common bolts in which the bolted distance between the nut and the head is altered to simulate different thicknesses of bolted structures.

It may also be desirable to ensure that the transducer arrangement used for the calibration plot measurements is the repeated in service. Hence, the same transducer, contact pressure and coupling medium may be used for both. It will be appreciated that the aforedescribed longitudinally displaceable transducer, described in connection with FIG. 2, may be particularly useful for this as it helps provide a repeatable contact pressure. The transducer 346 is shown as being concentrically arranged with respect to the longitudinal axis of the bolt, e.g. in the centre of the circular end face, however, this need not be the case, provided it corresponds to the calibration transducer arrangement. It will be appreciated that the rotational transducer arrangement described above can be advantageous in improving the placement of the transducer arrangement in addition to or as an alternative to the longitudinally displaceable transducer arrangement.

FIG. 4b shows the same plot as that of FIG. 4a but with a range of permissible loads. Thus, in use, the fastener may be interrogated during installation, as part of a commissioning process and/or in service (either periodically or continuously) and the results of the time of flight be used to determine whether the corresponding load is within the permitted range. The range may comprise either or both of an upper threshold 448a and a lower threshold 448b. There may additionally limits or ranges such as one or more intermediate thresholds which are each associated with an action, such as provide an indication of failure or a maintenance requirement. The measurements may be tracked over time to determine deterioration patterns and the like. It will be appreciated that the range of permissible load will be application specific and not detailed further here.

Although the calibration plot is represented by change of time of flight and load, it may be possible to use alternative parameters to obtain similar information in practice.

FIG. 3 shows a fastener 316 having a single transducer 346 which transmits and receives its own pulse. In some examples, it may be desirable to employ a plurality of transducers when using interrogating a fastener. The transducers, which may be referred to individually as transducer elements, may be spatially separated across a common face or mounting portion on the fastener so as to be adjacent one another, but suitably isolated where required. The transducers may be connected in parallel such that each of the transducers can transceive simultaneously. In other examples, the transducers may be connected to separate channels such that they can independently transceive.

In one example, it may be useful to have multiple transducers measuring different responses from the fastener. Thus, a first transducer of a plurality of transducers may be configured to determine a first parameter, and a second transducer may be configured to determine a second parameter. The first and second parameters may be used individually or in combination to determine a parameter of the fastener. In some examples, the different transducers may be configured to determine the same parameter from different positions and/or time separated responses.

One example of a multiple transducer arrangement is shown in FIG. 5. FIG. 5 shows an elongate fastener 516 in the form of a bolt. The bolt includes an end face, which may correspond to the threaded portion or the head of the bolt, upon which a plurality of transducers 546a, 546b may be mounted. In the example of FIG. 5, there are two transducers shown, however, this should not be seen as being limiting. There may be an array of transducers comprising more than two.

The transducers may be ultrasonic transducers and may be configured to transmit alternative waves into the fastener. The first and second transducers may be configured to transmit two different types of sonic wave into the fastener. A first transducer 546a of the plurality of transducers may be configured to transmit a first pressure wave. The second transducer 546b of the plurality of transducers may be configured to provide a first shear wave into the bolt. The pressure and shear waves may be referred to as longitudinal and transverse waves respectively.

Although the example of FIG. 5 comprises a plurality of transducers 546a,b to transmit the different waves into the bolt, it may be possible to excite a common ultrasonic transducer to transmit both the pressure wave and the shear wave.

The pressure wave transducer 546a may be assumed to be similar to that described above in relation to FIG. 3. Thus, there may be a transducer 546a which transmits a pressure wave into the bolt with the time of flight being determinative of the stress or loading experienced by the bolt. The shear transducer 546b operates in a similar manner in as much as the time of flight is affected by the loading in the bolt. However, the degree to which the time of flights is affected in the pressure wave and the shear wave is different. Hence, the differential response time from the transducers 546a,b may provide information relating to the loading of the fastener. Further, the different output signals from the longitudinal and shear transducers 546a,b may provide a ratio of longitudinal to shear time of flight which is independent of the fastener dimensions, making an associated calibration plot easier to determine. That is, the calibration bolt and in service bolt need only be made from material and may not have to have similar dimensions.

As noted above, in some embodiments, the length of the tensioned portion of the bolt may be relevant to the acoustic response received by the transducer(s) 546a,b. In particular, it may be necessary to determine what proportion of the bolt 516 is under tension with respect to the total length of the bolt 516 and/or with respect to the untensioned portion. The tensioned portion of the bolt 516 may correspond to the separation between the nut 550 and the bolt head 554. The total length of the bolt may be measured from bolt head end face 556 from which the pulses are reflected and the opposing end face to which the transducers are mounted. More specifically, the tensioned portion may be taken to be the length of the bolt 516 from the clamping surface of the nut 552 to the bolt head end face 556. The ratio of the tensioned portion to the total length of the bolt may be used to determine which calibration plot when assessing an installed bolt.

It will be appreciated that other metrics may be used to determine the relative length of the tensioned portion when assessing a particular bolt. The tensioned length may be determined from a measurement of the exposed threads or the distance between bolted component i.e. the surface against which the nut bears (or an associated washer), and the end face on to which the transducers are mounted.

Whatever the measurement taken from an installed bolt to characterise the ratio of the tensioned portion to the total bolt length or untensioned portion (or some combination thereof), it is necessary that this match the calibration plot in order for the comparison to be made. In some embodiments, each calibration plot may include a plurality of different descriptors relating to the tensioned portion length, the untensioned portion or the total length of the bolt to allow it to be matched to a particular installation measurement carried out by an operator. Such descriptors may be: a ratio of the free end length from the component surface to the terminal end of the bolt to a total length; the ratio of a tensioned portion to the total length; and the ratio of the exposed threads to the total length. Other examples may exist, such as a difference in the corresponding lengths, rather than a ratio.

The length of the tensioned portion may be determined during the installation of the bolt and calculated from the specifications of the components making up the installation. Thus, when the bolt is installed according to a particular specification which details a flange having fixed dimensions, the tensioned length may be predetermined.

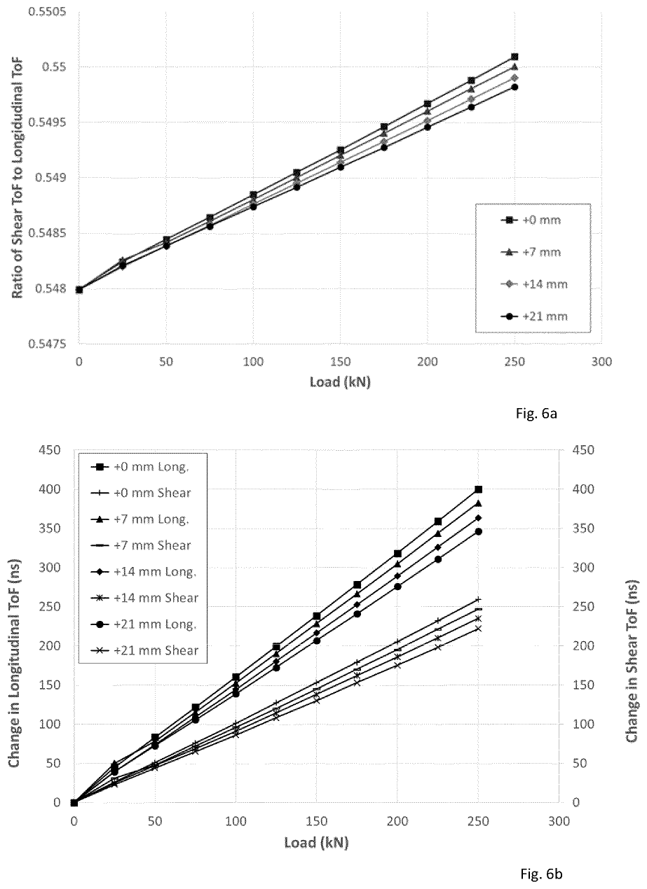

FIG. 6a shows a typical calibration plot of a longitudinal-shear transducer arrangement in which the x-axis shows force on the fastener, and the y-axis provides the ratio of the time of flight between the pressure and shear waveforms. As with the example of FIG. 4a, the data can be acquired empirically and determined from a test rig in which a fastener is stage loaded and the ratio of time of flight measured/determined for each stage. Thus, the transducers 546a,b may be pulsed sequentially or simultaneously provided the relative time of flights are known for the purposes of determining the time of flight ratio. Given the similarities with the example of FIG. 4a, further details will not be provided here for the sake of brevity.

FIG. 6a shows four separate plots, each of which correspond to a different ratio of tensioned portion length to total length. The ratio may be provided as a true ratio, as in a number from 0 to 1, or may be represented as a difference in the tensioned portion length with respect to a nominal tensioned portion length. Hence, the different plots are provided as 0 mm, 7 mm, 14 mm and 21 mm in which the 0 mm represents a nominal length in the tensioned portion and 7 mm representing a tensioned portion which is 7 mm longer than the nominal length. Thus, the component which is bolted by the 7 mm bolt is 7 mm thicker than the nominal component.

For each bolt of interest, the tensioned portion may be adjusted in the calibration set up to provide a corresponding set of data. Hence, although four data sets corresponding to different tensioned lengths are shown in FIG. 6a for a particular bolt, there may be fewer or greater numbers of data sets for a given bolt. In some examples it will be appreciated that the data may be extrapolated to provide a fuller data set corresponding to a greater number of tensioned lengths.

FIG. 6b shows separate data for each of the sensors shown in FIG. 5. Hence, there are shown change in longitudinal time-of-flight and change in shear time-of-flight measurements for different tensioned portion lengths to free end lengths for a plurality of bolts. This data can be used to provide the longitudinal to shear ratio plot similar to that shown in FIG. 6a.

It will be appreciated that there may be some parasitic coupling between the transducers and the signals transmitted and received by each transducer may interfere with the signals transmitted and received by the other transducer 546a,b. In order to reduce this, the transducers 546a,b may be spaced from each other by a suitable separating gap to prevent direct contact and provide some acoustic isolation. Further, the separating gap may be filled with an intermediate sound absorbing material 546c, such as a elastomeric potting material, e.g. rubber. Such materials and methods for mounting transducers 546a,b in a suitably acoustically isolated manner are well known in the art.

In a further example, a plurality of transducers may be distributed across the mounting surface to provide a spatial or temporal variance in the excitation. Thus, a fastener may have a mounting surface comprising a plurality of transducers distributed thereacross. The transducers may be arranged in a predetermined pattern or may be distributed randomly, as desired. A random arrangement of transducers may, for example, be useful to prevent interference patterns in the transmitted signals which may occur for some periodic spacings. This may be particularly useful where the mounting surface is limited in size.

Thus, the transducers may be arranged in a two-dimensional array. Alternatively, the transducers may be arranged in a one-dimensional array, e.g. a straight line. In the case of the one-dimensional array, the transducers may be radially distributed from a central point or portion of the mounting array towards a periphery of the mounting area. For example, in the case where the mounting area is provided by an end face of a bolt, the transducers may be distributed between a centre of the bolt (as denoted by the longitudinal axis), and the edge surface of the bolt.

As noted above, the distributed transducer arrangements may be used to determine a common parameter but from different locations or directions and/or at different times. In the case of an ultrasonic transducer arrangement, the transducer elements may all be excited with a pressure wave and/or a shear wave.

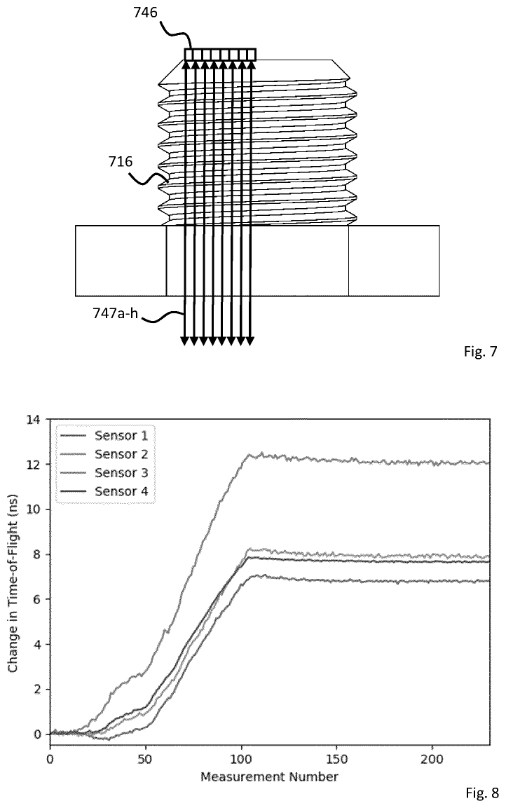

FIG. 7 shows an example of a multiple transducer array 746 in which there is provided a line of eight transducers extended from the central axis to the edge of the bolt end face. The transducers 746 may be separated from each other by at least a half wavelength of the ultrasonic frequency to avoid interference effects and or include intermediate sound absorbing material. It will be appreciated that a greater or fewer number of transducers may be employed in the transducer arrangement with the number being application specific. In some examples the number of transducers 746 may be between four and two hundred and fifty six.

The array of transducers 746 may be operable to determine the radial stress profile of the fastener. Thus, each transducer in the array of transducers 746 may be configured to transmit and receive a respective pulse 747a-h and record the time of flight for each radial position as determined by the individual transducer positions in the array 746. By examining the difference in the time of flight for each radial position may provide information about the radial stress profile. The radial stress profile may be indicative of the loading on the bolt and provide an advantageous way of determining whether a bolt is within a permissible range. Thus, for example, the radial stress profile acquired by the array of transducers 746 may indicate a greater degree of stress on the radial periphery of the bolt where the threads of the bolt engage with the nut and a stress concentration exists. The difference in this stress and the areas towards the centre of fastener can be used to determine whether a nut is over or under torqued or there is a potential flaw in the stress profile of the bolt.

The permissible range in the radial differential may relate to the difference in the time of flight between a first transducer position and a second transducer position. Thus, the difference of time of flight between a first, central transducer, and a second, peripheral transducer, may be determined and compared to a permitted difference which is indicative of an acceptable level of loading. The intermediate transducers between the peripheral outer transducer and radial inner transducer provide a greater insight into the stress distribution across the bolt and allow for the detection of a faulty reading from one or more of the transducers in the array of transducers.

FIG. 8 shows a set of calibration plots taken for a stage loaded fastener having a radial distribution of transducers. The calibration plot may be obtained in a similar way to that shown in FIG. 4a in that the fastener may be stage loaded and the time of flight from each transducer measured for each stage. The corresponding time of flight measurements obtained from an in-service fastener may then be used to determine the stress level in the fastener. The example of FIG. 8 shows an arrangement including an array of four transducers, however, this is not limiting and, as noted above, there may be a greater or fewer number of transducers in the array.

In one example, the plurality of transducers in the array 746 may be connected in parallel so as to receive simultaneous inputs for transmission at the same time. Doing this provides a temporally distributed spread of reflected waves by virtue of the differential time of flight of each longitudinal path below each transducer in the array of transducers 746. Hence, the reflected waves are received at slightly different times providing a width to the response envelope, the width being indicative of the time difference between the first transducer response and the second transducer response. The width of the response may be compared to known envelope widths as provided, for example, by calibration data which may be captured empirically, as described above.

Thus, the output from the transducers in the array 746 may include an overlap of reflected signals which extends from a first time of flight to a second time of flight, wherein the extent of the overlap of reflected signals, which may be referred to as the response envelope, may be used to determine the load applied to the fastener.

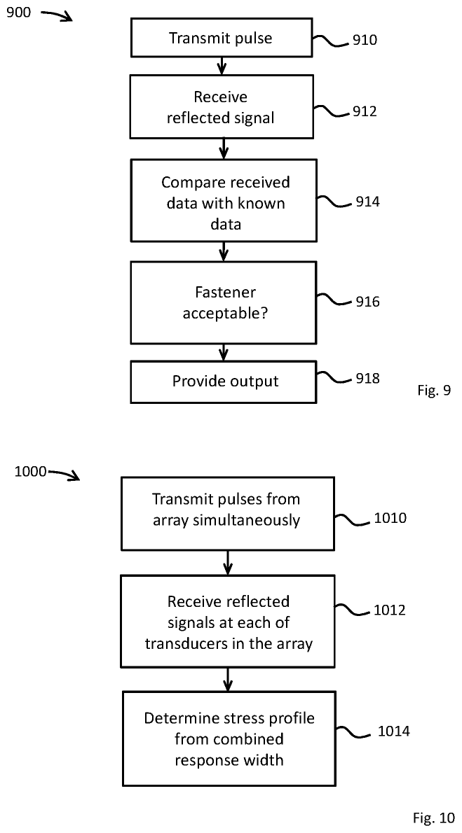

FIG. 9 shows a method of operating a sensor arrangement 900 comprising a transducer arrangement according to the present disclosure. The sensor arrangement may comprise a single transducer or an array of transducers. The transducer or array of transducers may be operable to transmit and receive a pressure wave, a shear wave or both. In the case of an array, the signals may be transmitted simultaneously or temporally separated, as required. Thus the transducers may be connected in parallel on a common channel, or on multiple separate channels. Prior to the measurement method according to FIG. 9 being executed, it will be appreciated that the sensor arrangement has been mounted to the fastener in question in the required manner, as described above and using techniques known in the art.

At step 910, an ultrasonic signal is transmitted into the fastener. The signal may be in the form of a pulse as is well known in the art. As noted in the preceding paragraph, the signal may be transmitted from one or more of the transducers in the array of transducers simultaneously or sequentially. Following transmission, the reflected signals are received at step 912 and the received data compared to known data at step 914. As noted above, data may correspond to or be representative of a time of flight, a ratio of time of flights or some other measure which may provide an indication of a parameter of the fastener.

The known data may be historic data or empirically derived data acquired from a test rig. The historic data may be provided by operational fasteners collected over a period of time. The historic data may be obtained from a particular installation, an installation site or multiple independent sites. Thus, historic data may be collected for a particular fastener over time and/or a database of measurements may be amassed for a particular type of bolt, for example. It will be appreciated of course that the historic data will nonetheless be relevant data comprising measurements from related fasteners to allow a proper comparison.

The empirically derived data may include data relating to different fasteners tested in a test rig in which the parameter of interest has been altered. Thus, in some embodiments, the empirically derived data may include data from a range of different fasteners which are measured under different loading conditions, e.g. different tensions, for a plurality of bolted lengths. The bolted lengths may be considered to be the axial separation of the nut and the bolt head. The bolted lengths may be expressed as ratios of the tensioned portion of the bolt to the total length of the bolt. Alternatively, the bolted length may be expressed as the untensioned length or exposed thread length, as described above.

In the case of FIG. 5, each of the fasteners may have a different tensioned length to total length ratio in which different thicknesses of flanges (or other fixed components) are used to develop the data. Thus, a first set of data may comprise a plurality of time of flights or time of flight ratios (or other parameters) for a first flange thickness, and a second set of data comprising a plurality of time of flights or time of flight ratios for a second flange thickness, wherein the fastener is the same for the different sets. Each of the data sets may comprise data points for different tensions in the fasteners.

The comparison with the known data may lead to a determination of whether an installed state, e.g. the operational stress or some other parameter, is within predetermined acceptable limits 916 and an output provided 918. The output may be dependent on the determination of the fastener condition. The output may comprise one or more of: storing the data (for future reference); a null output in which no further action is taken and the measurement data discarded; an indication of the installed state to an operative; a recommendation to an operative; and, a warning to an operative or other user. The operative may be the person controlling the operation of the test who may be local or remotely situated. The operative may be an engineer for example. The indication, recommendation or warning may be provided in any convenient manner such as a visual or audible alarm, plot, chart or report. Thus, an operator may be provided with detail of the stress profile or some other quantifiable data such as a torque level which has been determined from the collected data. In other examples, an operator may be provided with a colour coded visual display such as a green light indicating an acceptable installation, or a red light indicating that the fastener should be re-torqued or investigated further. In other embodiments, the output may be provided in the form of a written report stating an estimated condition of the fastener and assessment of the parameter being investigated.

The parameter may be a time of flight, an elongation of the fastener, a radial stress profile, the presence of one or more stress concentrations, the deterioration of the fastener, the torque level of a nut or bolt head, an axial stress profile along a plane or any other which may be of interest.

In order to carry out the measurements, as indicated above, the transducers may be connected to a signal generator which provides a required pulse. Each transducer is pulsed in sequence and the output from the pulsed transducer measured to determine the time of flight, which is recorded and stored. Thus, the method may include transmitting a first pulse into the fastener from a first transducer, receiving the reflected pulse with the first transducer; transmitting a second pulse with a second transducer, receiving the reflected pulse and so on until all of the transducers have been used in the transmit and receive process. After the transmit and receive has been completed (or during the subsequent transmit/receive), the method may, for example, further comprise determining the time of flight for each of the transducers and a comparison with the calibration plot to determine load. The comparison with the calibration data may include a comparison of individual transducer data, a differential between the flight of any combination of the transducers, for example, the innermost and outermost transducers, or the width of the response envelope or any other data associated with the parameters defined herein.

FIG. 10 provides a method 1000 in which the transducers in an array transmit pulses simultaneously 1010, the reflected signals are received within a receiving envelope 1012 and the stress profile determined from the width, i.e. the duration, of the receiving envelope 1014. The pulses may be transmitted from one or more of the transducers and may be received by one or more of the transducers. In some embodiments, pulses are transmitted by one transducer and received by all of the transducers. In other embodiments the pulses are transmitted by all and received by all. Other combinations are possible. It will be appreciated that the determination as to which transducers are used to transmit and receive is dependent on the information which is required.

Each of the measurement methods described above may be used in combination or individually. Thus, for example, the plurality of transducers may be used to determine a radial distribution of stress and an axial distribution in subsequent measurement phases of a given measurement. It will also be appreciated that the wireless transceiver, relative rotational movement and relative longitudinal movement may be provided in the same or different examples.

The above examples rely on detecting an elongation of the fastener or a radial profile of stress. In another example, the transducer arrangement may be used to determine an axial stress profile, that is, the stress profile along the length of the fastener. In particular, the transducer arrangement may be used to determine a stress profile in a longitudinal plane. The plane may coincide with a plane defined by a linear distribution of the array of transducers and the longitudinal axis of the bolt.

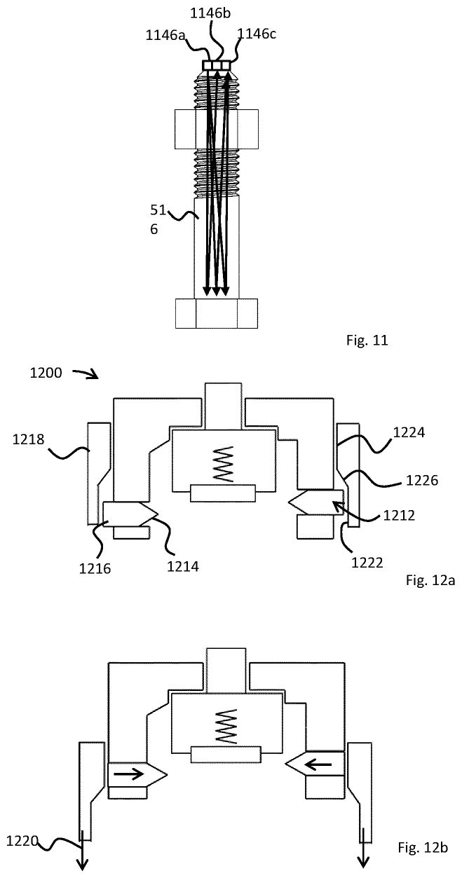

Hence, in FIG. 11 there is shown an array of transducers 1146a-c which extends across the mounting surface of the fastener from one side to the other so as traverse the central region thereof. Thus, the transducers 1146a-c are radially distributed on either side of the central axis. The number of transducers is shown as being three for the ease of explanation, but it will be appreciated that any number of transducers may be used in practice. A typical number of transducers may be between four and twelve, with eight being preferable in some applications. The transducers may be connected to separate channels so as to be independently operable.

In the example shown in FIG. 11, each of the transducers 1146a-c is pulsed in sequence and the reflected wave measured by each of the other transducers 1146a-c, including the input transducer. More specifically, a first transducer 1146a may transmit a pulse into the fastener with the reflected wave being received by all of the transducers in the array 1146a-c. Subsequently and sequentially, the other transducers 1146b and 1146c in the array may transmit pulses into the fastener and with all of the transducers receiving the reflected signals.

In this way, it is possible to obtain acoustic information from different angles and positions across the longitudinal plane of the bolt. The acquired data may be reconstructed using known tomographic techniques to provide an axial or two dimensional stress profile. The longitudinal stress profile may be presented to a user, e.g. an operator or engineer, in any desired way, including one or more of: an approximate figure for the load or stress; an alert providing an advisory action or warning; an alert indicating that the fastener is within acceptable limits etc.

FIGS. 12a and 12b show an alternative design for a sensor arrangement providing an alternative attachment mechanism in place of the threaded engagement shown in FIGS. 1 and 2. Thus, there is provided a sensor arrangement 1200 comprising a clamp which engages with a free end of a fastener. The clamp may engage with a threaded portion of non-threaded portion of a fastener. The clamp may laterally engage the end of a fastener. In some examples, the clamp may comprise a plurality of laterally translatable engagement features 1212 which are configured to be moved radially inwardly upon actuation to engage with a portion of the fastener. The engagement features 1212 may comprise laterally displaceable fingers or webs comprising an engagement end 1214 and an abutment end 1216. The engagement features 1212 may extend circumferentially around the periphery of the insertion cavity which receives the fastener such that the exposed length of the engagement end 1214 which contacts the fastener has a greater circumferential length to increase the contact area.

As shown in FIG. 12, the engagement features 1212 may be axially offset in relation to one another such that they can engage with a thread. Hence, the axial offset may correspond to the pitch of a fastener thread.

The engagement features 1212 may take any desirable shape. In some examples the engagement end 1214 of the engagement features may be provided plates or jaws which clamp an external surface of fastener to provide a compressive gripping force, so as to provide a collet. In other examples, the engagement ends 1214 may project into or interleave with features of the fastener. Hence, as can be seen in FIG. 12, the engagement portion of the engagement end 1214 may be profiled to match a thread profile. This may comprise a tapered portion or similar shaped to match a desired thread profile, as shown. The tapered profile may additionally assist with axially locating the sensor arrangement with respect to the fastener. That is, one of the tapered sections may abut a corresponding portion of the fastener and urge the sensor arrangement downwards onto the fastener during actuation by virtue of the slope of the taper.

The actuation of the engagement features 1212 requires a lateral displacement from a stowed position in which the fastener is inserted (FIG. 12a) to a deployed position in which the sensor arrangement is secured to the fastener for measurements (FIG. 12b).

In the example shown in FIGS. 12a and 12b, the sensor arrangement includes a sleeve 1218 which is axially displaced from a rearward position to a forward position as indicated by arrows 1220 in FIG. 12b. The sleeve 1218 may be provided by an annular member which encircles the transducer arrangement. A rebate may be provided on an internal surface of the sleeve 1218 towards a forward end such that it can receive the engagement features when in the stowed, non-engaging position. The rebate provides a first diameter 1222 and a second diameter 1224 which is less than the first diameter. The first narrower diameter 1222 transitions to the second diameter 1224 via a ramped portion 1226. Thus, moving the sleeve from a forward position to a rearward position results in an engagement between the ramped portion 1226 engaging the abutment end 1216 of the engagement features and urging them forwards into engagement with the fastener. Upon full actuation of the sleeve 1218, the engagement features are located by the narrower radius of the sleeve 1218 in an extended and engaged position. It will be appreciated that, once actuated, the sleeve 1218 may be retained in place via a friction fit with the engagement features or may be held in place by some form of retention mechanism.

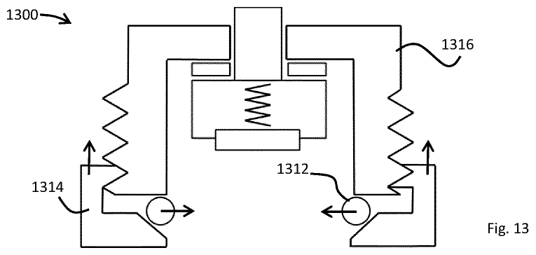

A further alternative is provided in FIG. 13. FIG. 13 shows a sensor arrangement 1300 comprising a compression member 1312 which is engaged via a nut 1314. The compression member 1312 may comprise a collet, as are known in the art, or a compression ring. The compression member 1312 may be located adjacent an inner taper of the nut 1314 such that tightening the nut 1314 onto the housing 1316 causes the compression ring 1312 to move radially inwards into compressive engagement with a portion of the fastener. The compression ring may be segmented. The nut may engage with a threaded portion located on in external proximal portion of the transducer housing 1316. The compression member 1312 may be used in conjunction with the axially sliding sleeve of FIG. 12. Further, the sleeve of FIG. 12 may comprises a threaded portion to enable it to be screwed over the laterally moving engagement features.

In some embodiments, measurements may be taken for a plurality of fasteners at a particular location and averaged to provide an installation reading for the condition of the fasteners. Thus, a particular wind turbine tower may have some or each of its fasteners interrogated using any of the methods described herein and the results of the measurements may be averaged to provide a general status of the fasteners. The averaged measurements may comprise the fasteners from a single flange.

In some embodiments, the transducer arrangement may be used to measure the interface between the flange (or other component the fastener is fastening or fastened to). Thus, a condition of the interface may be monitored for corrosion or the like. Additionally or alternatively, the transducer arrangement may be used to measure the stress in the bolted component by mounting the transducer element to the component rather than the fastener.

It will be understood that the invention is not limited to the examples and embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein. For example, the longitudinally displaceable transducer may be used in conjunction with the rotatable transducer. Similarly, any of the transducer arrangements may include one or a plurality of transducers. In the case of a plurality of transducers, these may be configured to operate in a plurality of the ways to undertake the methods described herein with a single transducer arrangement. Thus, a single transducer arrangement may be configured to obtain a time of flight to determine elongation of the fastener, a ratio of time of flight for pressure and shear waves, a radial stress profile and/or an axial profile in subsequent tests whilst connected to a single fastener.

1. A method of determining a parameter of a fastener, comprising:
providing an input to an ultrasonic transducer of a transducer arrangement, wherein the transducer is attached to a fastener and the input results in the transmission of an ultrasonic wave into the fastener;
receiving a transducer output from the ultrasonic transducer, the transducer output being indicative of a reflected ultrasonic wave received by the ultrasonic transducer; and
comparing the transducer output to known data for the parameter to determine whether the parameter of the fastener is within a predetermined range.

2. A method according to claim 1, further comprising providing an output signal to a user, wherein the output signal is indicative of a condition of the fastener, wherein the condition of the fastener relates to the determination of whether the fastener is within the predetermined range.

3. (canceled).

4. A method according to claim 1, wherein the transmission is a first ultrasonic transmission, wherein the method further comprises providing a second input to the ultrasonic transducer, wherein the second input results in a second ultrasonic transmission into the fastener, and wherein the parameter is a ratio of a time of flight between the first and second ultrasonic transmissions.

5. (canceled)

6. A method according to claim 1, wherein the known data comprises a plurality of measurements taken from one or more fasteners having different tensioned portion lengths.

7. A method according to claim 6 wherein the known data comprises a calibration plot, the calibration plot including a relationship between the taken plurality of measurements and the one or more fasteners having different tensioned portion lengths.

8. A method according to claim 6, wherein the tensioned portion length corresponds to the separation between an end face of the fastener against which the ultrasonic transmissions are reflected and a nut of the fastener.

9. A method according to claim 6, wherein the known data comprises a ratio of the tensioned portion length to the total length of the fastener.

10. A method according to claim 1, further comprising obtaining the known data, wherein the known data are determined empirically from stage loading one or more fasteners and/or comprise historic data for a fastener.

11. A method according to claim 1, wherein the transducer comprises a plurality of transducer elements arranged in an array on a portion of the fastener, the method further comprising:
providing a respective input to each of the transducer elements, each input resulting in the transmission of a respective ultrasonic wave into the fastener;
receiving a transducer output, the transducer output being indicative of reflected ultrasonic waves received by each of the transducer elements; and
determining a stress profile for the fastener on the basis of the transducer output.

12. A method according to claim 11, wherein the input causes each transducer element to simultaneously transmit an ultrasonic wave.

13. A method according to claim 11, wherein the stress profile is a radial stress profile.

14. A method according to claim 13, wherein determining a stress profile comprises comparing the time of flight of any two of the received reflected ultrasonic waves.

15. A method according to claim 11, further comprising determining the duration of a response envelope, wherein the response envelope comprises the received reflected ultrasonic waves from each of the transmitted inputs from each of the transducer elements.

16. A method according to claim 11, wherein the stress profile comprises an axial section.

17. A method according to claim 16, further comprising determining the axial section using tomography techniques.

18. A method according to claim 17, wherein receiving the reflected ultrasonic waves by the transducer elements comprises receiving the reflected ultrasonic waves resulting from each of the inputs of the transducer elements at each of the transducer elements.

19. A method according to claim 1, wherein the ultrasonic transducer comprises an RF transceiver, the method further comprising:
providing the input from the reader;
receiving the output via the reader.

20. (canceled)

21. (canceled)

22. (canceled)

23. (canceled)

24. An apparatus configured to perform the method of claim 1.

25. A method of determining a parameter of a fastener, comprising:
providing an input to a plurality of ultrasonic transducer elements of a transducer arrangement, wherein the transducer elements are attached to a fastener and the input results in the transmission of a plurality of ultrasonic waves into the fastener from the transducer elements;
receiving the reflected ultrasonic waves by the transducer elements and
determining a stress profile for the fastener on the basis of the received reflected ultrasonic waves.

26. A method of determining a plurality of calibration plots for use in determining a parameter of a fastener, comprising:
measuring, for a plurality of fasteners, the parameter under different conditions wherein the different conditions comprise a plurality of tensioned length to total length for each of the plurality of fasteners.
